(19) United States
(12) Patent Application Publication
(10) Pub. No.: US 2012/0168049 A1
(43) Pub. Date: Jul. 5, 2012

(54) TIRE WITH A SIPE HAVING AREAS WITH REDUCED THICKNESS AND APPARATUS FOR MAKING THE SAME

(76) Inventors: Brian William Jenkins, Greenville, SC (US); David Scott Morgan, Greenville, SC (US); Timothy A. White, Greer, SC (US)

(21) Appl. No.: 13/320,040

(22) PCT Filed: May 13, 2009
(86) PCT No.: PCT/US09/43772

§ 371 Date: Jan. 12, 2012

(51) Int. Cl. B60C 11/12; B29D 30/00

(52) U.S. Cl. 152/209.21; 425/28.1

(57) ABSTRACT

A tire has a sipe with areas of reduced thickness. The sidewalls of the sipe may have undulations that extend both in the radial and transverse directions of the tire and the areas of reduced thickness are found in between a peak to peak or a valley to valley coincidence of the undulations. Twice the value of the amplitude of the undulations in the radial direction of the tire is greater than 95% of the value of the half pitch of those undulations. The ratio of the area of the regions of the sipe having reduced thickness to the area of the thicker regions of the sipe may meet a minimum threshold. The apparatus may also include a sipe blade that extends from a curing member that for tire molding or retreading.

### BACKGROUND OF THE INVENTION

1. Field of the Invention

This invention relates generally to a tire that has one or more sipes having areas of reduced thickness and an apparatus for creating such a tire, and more specifically, to a tire that has a sipe with areas of reduced thickness that has undulations in a radial direction and in a transverse direction of a tire and to a sipe blade that is capable of forming such a sipe in a tire.

2. Description of the Related Art

Sipes, which are thin slits found in the tread stock of a tire, are routinely used for enhancing performance characteristics of tires. They are frequently found within tread elements, such as blocks and/or ribs that are formed by the grooves found in the circumferential and/or transverse directions of the tires. Alternatively, other grooves found at other angles or directions on the tread stock can form these tread elements. It is known that the extra edges provided by sipes where they intersect the circumference of the tire increase the ability of the tire to adhere to a surface such as a road, which is good for handling and braking under wet conditions. These extra edges are particularly advantageous in reducing viscoplaning, improving wet traction. Also, siping provides surface edges and flexibility to a tread element, such as a tread block, that enhances snow traction. In addition, siping increases the flexibility of the tread element or block as it enters and exits the contact patch of the tire, which is where the tire contacts a road, reducing stress for improved wear performance, as well as reducing the generation of heat, thereby decreasing rolling resistance and increasing fuel efficiency. Hence, wet traction, snow traction, rolling resistance and wear performance of a tire can be improved by adding sipes to a certain extent. However, it is difficult to use siping in such a manner that all these performances are improved simultaneously.

In addition, it is also known that excessive siping or poor use of siping can increase hysteretic losses within a tread element or block and can increase rolling resistance, decreasing fuel efficiency. Siping decreases tread block rigidity which can degrade dry traction and wear life once the tread element is adherent in the contact patch. Accordingly, it is desirable to a high number of sipes when the tread element or block is entering or exiting the contact patch to increase the flexibility of the tread, but to have as few sipes as possible when the tread element or block is in contact with the road so that the tread element is as stiff as possible.

Accordingly, there still exists a need for a configuration of a sipe that allows a tread element to be as flexible as possible when the tread element enters or exits a contact patch and that also allows the tread element to be as stiff as possible when the tread element is in the contact patch in order to improve the traction, handling characteristics, wear performance and rolling resistance of a tire simultaneously.

### SUMMARY OF THE INVENTION

A tire with a radial direction according to an aspect of the present invention comprises a tread stock with a tread element and a sipe located within the tread element that has first and second opposing sidewalls. The first sidewall has a first set of undulations in a radial direction of the tire that has a half pitch and amplitude wherein twice the value of the amplitude is greater than 95% of the value of the half pitch. The sipe has a thicker region with said opposing sidewalls being spaced apart a first predetermined distance and a region having a reduced thickness with the opposing sidewalls being spaced apart a second predetermined distance. The second predetermined distance is less than the first predetermined distance and the sidewall of the region with a reduced thickness has a surface area that is at least 25% and less than 85% of the surface area of the sidewall of the thicker region of the sipe.

In certain embodiments, the half pitch of the undulations in the radial direction may range from approximately 0.7 millimeters to 1.25 mm and the amplitude may range from approximately 0.4 millimeters to 0.625 millimeters with twice the value of the amplitude always being greater than 95% of the value of the half pitch. In other embodiments, the tread element may have a top surface and the sipe may have a chamfer where the sipe meets the top surface of the tread element.

The sipe of the tire may have sidewalls that are complimentary shaped to each other and the region having reduced thickness can be formed by first and second protrusions found on a sidewall. In certain embodiments, the sipe further comprises a second set of undulations in a direction that is substantially perpendicular to the radial direction of the tire. The half pitch and amplitude of either set of undulations may vary within the sipe.

In other embodiments, the undulations of the first sidewall in the radial direction of the tire has a midplane and the undulations of the first sidewall in a direction that is substantially perpendicular to the radial direction of the tire also has a midplane, and the midplanes of both sets of undulations are coplanar. Furthermore, the first set of undulations of the first sidewall in the radial direction of the tire may vary in a manner that is similar to a periodic wave with a starting point of zero amplitude and the second set of undulations of the first sidewall in a direction that is substantially perpendicular to the radial direction of the tire may also vary in a manner that is similar to a periodic wave with a half pitch and an amplitude and also has a starting point of zero amplitude. Both starting points may be aligned in the direction of the tire that is substantially perpendicular to the radial direction.

In certain applications, the undulations in both the radial direction of the tire and a direction that is substantially perpendicular to the radial direction of the tire may have peaks and valleys that periodically coincide with each other. The peaks of one set of undulations may periodically coincide with the peaks of the other set of undulations and the valleys of one set of undulations may periodically coincide with the valleys of the other set of undulations. In some situations, the region of the sipe having reduced thickness includes at least one peak or valley. In other situations, the region of the sipe having reduced thickness does not include a peak to peak or valley to valley coincidence.

A tire with a tread element according to an aspect of the present invention may have a sipe that has a half pitch and an amplitude of the undulations in the radial direction of the tire be different than the half pitch and amplitude of the undulations in the direction that is substantially perpendicular to the radial direction of the tire. In such a case, the half pitch can be approximately 3.7 millimeters and the amplitude can be approximately 0.75 millimeters for the undulations in the direction of the tire that is substantially perpendicular to the radial direction. Also, the half pitch and amplitude of the undulations in either the radial direction or the direction that is substantially perpendicular to the radial direction may vary within the sipe.

An apparatus for molding or retreading a tire having a tread and a radial direction according to another aspect of the present invention includes a curing member that has a curing surface that contacts the tread of the tire and a sipe blade that has a first set of undulations in a radial direction with a half pitch and an amplitude wherein twice the value of the amplitude is greater than 95% of the value of the half pitch. The second set of undulations is in a direction that is substantially perpendicular to the radial direction of a tire. The first or second set of undulations may form at least one peak or valley and at least one peak to peak or valley to valley coincidence. The sipe blade may have a thicker portion that extends from the curing member and a portion having a reduced thickness that includes at least one peak or valley.

Both sets of undulations of the sipe blade in the radial direction and in a direction that is substantially perpendicular to the radial direction may vary in a periodic manner and have peaks and valleys that periodically coincide with each other with at least one peak to peak or valley to valley coincidence. The portion of the sipe blade having a reduced thickness may not include any peak to peak or valley to valley coincidence. Furthermore, the sipe blade may comprise a series of portions having reduced thickness that are found between each of the peak to peak or valley to valley coincidences of the blade. One set of undulations may have a different half pitch and amplitude compared to the other set of undulations.

The sipe blade of the apparatus may have an amplitude for the undulations in the radial direction that is approximately 0.5 millimeters and a half pitch of 0.9 millimeters while the amplitude for the undulations in the direction of the tire that is substantially perpendicular to the radial direction may be approximately 0.75 millimeters and the half pitch may be approximately 3.7 millimeters.

The foregoing and other objects, features and advantages of the invention will be apparent from the following more detailed descriptions of particular embodiments of the invention, as illustrated in the accompanying drawings wherein like reference numbers represent like parts of the invention.

### BRIEF DESCRIPTION OF THE DRAWINGS

FIG. 1A is a perspective view of a tire with sipes in its tread blocks according to a first embodiment of the present invention where the sipes have a zigzag configuration as the sipe exits a lateral surface of the tread block showing that radial undulations are present across the entire width of the sipe;

FIG. 1B is a perspective view of a tire with sipes in its tread blocks according to a second embodiment of the present invention where the sipes have a straight configuration as the sipe exits a lateral surface of the tread block showing that radial undulations are hidden within the tread block;

FIG. 2 is a top view of the tire of FIG. 1B having sipes oriented in a purely transverse direction for clarity;

FIG. 3 is cross-sectional view of the tire of FIG. 2 taken along line 3-3 thereof showing the cross-section of the thicker region of the sipe at a crest portion on the sipe that is found on the left side of the sipe;

FIG. 4 is a cross-sectional view of the tire of FIG. 2 taken along line 4-4 thereof showing the cross-section of the thicker region of the sipe at a crest portion on the sipe that is found on the right side of the sipe;

FIG. 5 is a cross-sectional view of the tire of FIG. 2 taken along line 5-5 thereof showing the cross-sectional view of the region of the sipe having reduced thickness;

FIG. 6 is cut away view of a tread block removed from the tire of FIG. 1B showing a sidewall of the sipe and projections for forming areas of the sipe having reduced thickness more clearly;

FIG. 7 is a top view of the tire of FIG. 6 with the undulations in the radial direction, projections for forming the areas of the sipe having reduced thickness, and the bottom of the sipe removed so the undulations in the transverse direction of the tire can be more clearly seen;

FIG. 8 is a cross-sectional view of the tread block of FIG. 6 taken along line 8-8 thereof with the transverse undulations hidden;

FIG. 9 is a perspective view of an apparatus that forms the sipe of the tire of FIG. 1B with projections for forming the grooves that define the tread blocks of the tire removed for clarity; and

FIG. 10 is perspective view of the sipe blade of the apparatus of FIG. 9.

### DETAILED DESCRIPTION OF PARTICULAR EMBODIMENTS

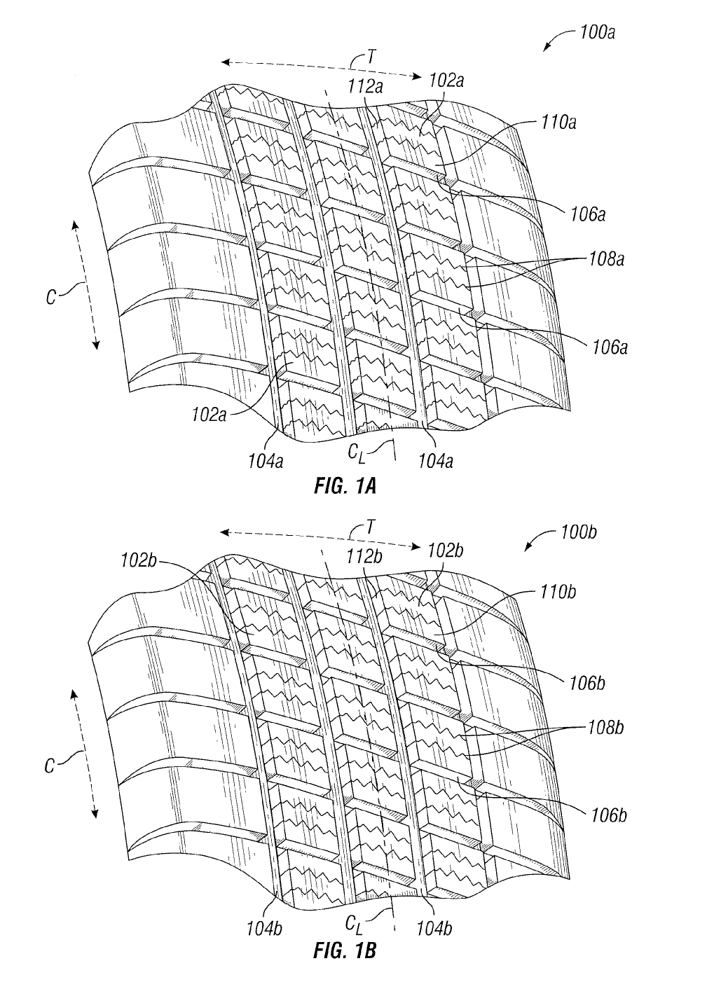

Looking at FIGS. 1A and 1B, there is shown two embodiments of the present invention. They comprise, in part, a tire 100a, 100b that has a series of tread elements in the form of tread blocks 102a, 102b that are defined by circumferential and transverse grooves 104a, 104b, 106a, 106b found along the tread stock of the tire in the circumferential and transverse directions of the tire. The term, “tread stock”, may refer to the tread of a tire formed in a toroidal mold, or equally to a procured tread for use in retreading a tire. For reference, the circumferential direction C is the direction in which the tire rolls and is parallel with the centerline C_{L} of the tire. The transverse direction T is perpendicular to the circumferential direction and parallel with the axis of rotation (not shown) for the tire. Looking at the tread blocks 102a, 102b, they have a series of sipes 108a, 108b found within them that have a particular configuration according to an aspect of the current invention that increases the traction and flexibility of the tread block when it comes into contact with a surface such as a road but that allows the sipe to lock up when the tread block is in full contact with the road, enhancing the stiffness of the tread block and reducing the amount of rolling resistance of the tire. In the first embodiment as shown by FIG. 1A, the sipe 108a forms a zigzag configuration with the top and lateral surfaces 110a, 112a of the tread block 102a while the in second embodiment as shown by FIG. 1B, the sipe forms a zigzag configuration with the top surface 110b of the tread block and a straight configuration with the lateral surface 112b of the tread block 102b as it exits the tread block. Of course, it is contemplated that the reverse situation where the sipe forms a straight configuration with the top surface of the tread block and a zigzag configuration with the side surface could also be used. Accordingly, these figures are meant only to show that the way the sipes look externally is not essential to the present invention but it is the internal geometry that is important. Likewise, the shape of the tread elements can have any desired shape, such as ribs or blocks with any suitable perimeter formed by grooves oriented at any direction, including but not limited to the transverse and circumferential directions. It is also contemplated that the sipes could be found in the shoulders of the tire.

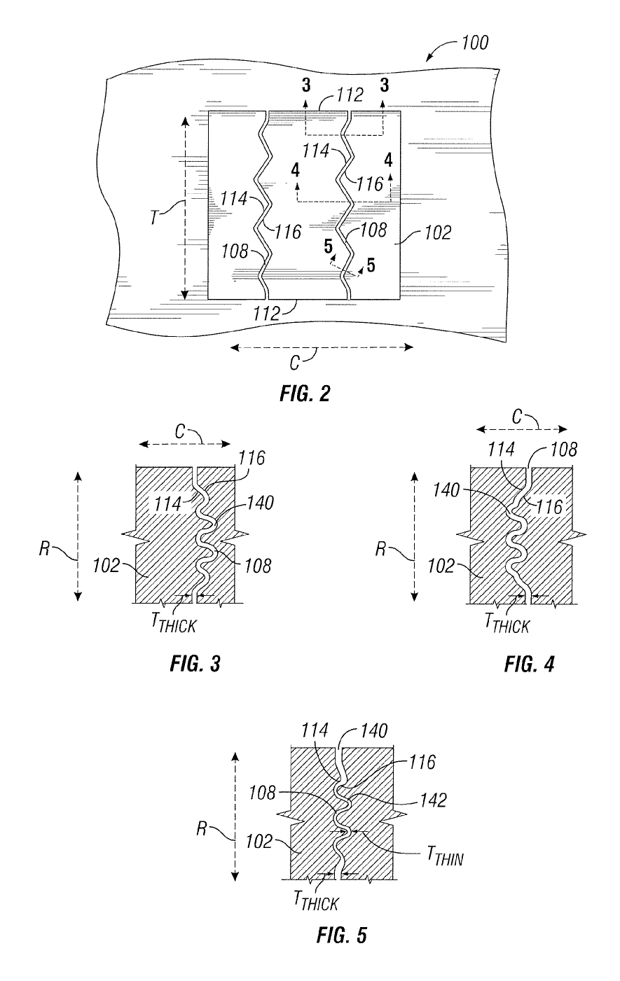

Focusing on FIGS. 2-8, the features and construction of the sipe 108 shown in the tire of FIG. 1B can be clearly seen (for brevity, the suffix b will be omitted from the reference numerals in these figures and any thereafter as it is to be understood that all these numerals pertain particularly to the features of the sipes of the tire shown in FIG. 1B). It comprises, in part, opposing sidewalls 114, 116 that end in a bottom surface 118 found below the top surface 110 of the tread (see FIGS. 2-6). Each sidewall 114, 116 has a first set of undulations that extend in the transverse direction of the tire and produce an undercut in that direction. While the undulations are shown in a purely transverse direction, it is to be understood that this a general representation of the direction in which these undulations extend and the “transverse” direction includes any slight deviation in angle that is common in tire design to minimize the problems such as noise associated with sipes that are oriented in a purely transverse direction. Also, these undulations may extend in any direction that is substantially perpendicular to the radial direction in addition to a purely transverse direction.

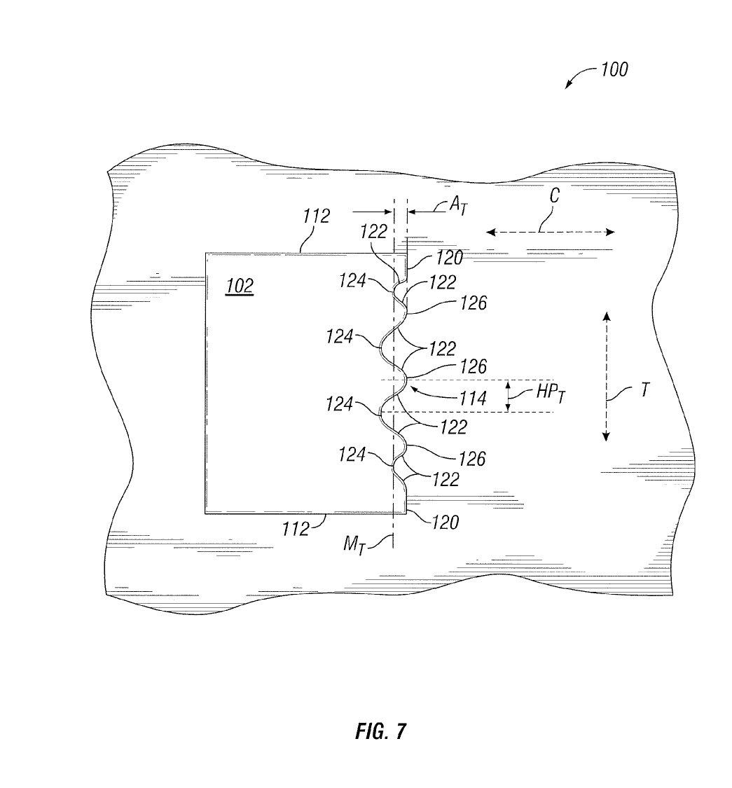

As can be clearly seen in FIG. 7 since the undulations in the radial direction R and the projections for forming the regions of the sipe having reduced thickness have been removed, these undulations begin with a straight section 120 that extends from a first lateral surface 112 of the tread block that transitions to a first angled section 122 that blends into a radius, forming a valley 124, which in turn leads to another angled section 122 that then leads into another radius section that forms a peak 126. Thus, the first set of undulations has a repeating wavy pattern, similar to a sinusoidal wave but not necessarily having the exact same geometry (a saw tooth or similar profile could be used). This pattern terminates with another straight section 120 that leads to the second lateral surface 112 of the tread block 102. The first valley 124 as measured from either lateral surface 112 of the tread block 102 does not have the full depth or protrusion as it is intended to allow the undulations to build up to a maximum amplitude gradually. Therefore, starting with the first peak 126 as measured from either lateral surface 112 of the tread block 102, the amplitude A_{T} of these undulations is 0.75 mm (approximately 0.030 of an inch) as measured from a peak or valley (surface of the sidewall 114, 116) to the midplane M_{T} of these undulations in the circumferential direction C. Likewise, the half pitch HP_{T} is 3 7 mm (approximately 0.147 of an inch) as measured from peak 126 to valley 124 in the transverse direction T of the tire. While it is shown that the transverse undulations stop short of either lateral surface of the tread block, it is possible that they could extend to either or both lateral surfaces. In addition, it is possible that the half pitch and amplitude of these undulations could be changed and still fall within the scope of the present invention. For example, the amplitude A_{T} could be 1.0 mm (approximately 0.04 of an inch) and the half pitch HP_{T} could be 5 mm (approximately 0.198 of an inch) or the values of A_{T} and HP_{T} could be varied within the sipe or there could be no undulations at all in this direction.

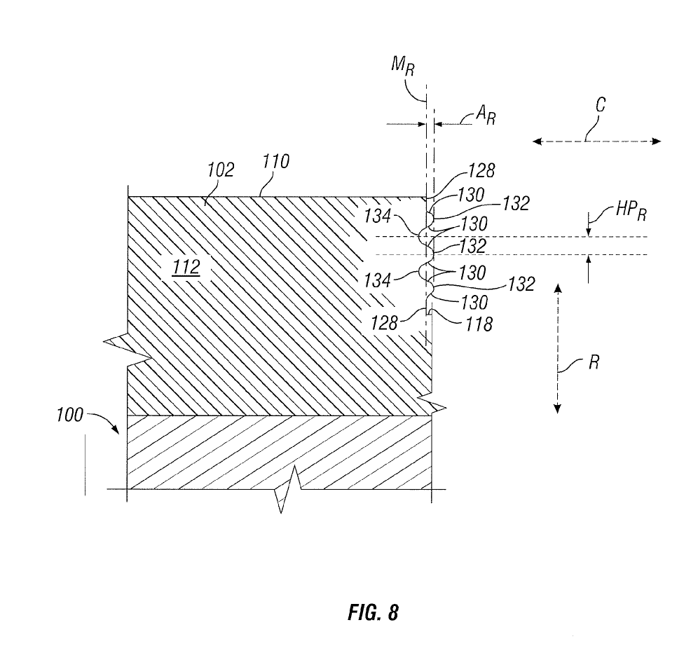

As best seen in FIG. 8, the sipe 108 also comprises a second set of undulations that extends in the radial direction R of the tire, producing an undercut in that direction, and that has a similar configuration to the first set of undulations. While the undulations are shown in a purely radial direction, it is to be understood that this a general representation of the direction in which these undulations extend and the “radial” direction includes any slight deviation in angle that is common in tire design and that can be successfully molded and demolded. The second set of undulations starts a predetermined distance below the top surface 110 of the tread block 102 following a straight section 128 and comprises a series of angled sections 130 and radius sections that alternate about a midplane M_{R} to form peaks 132 and valleys 134. The undulations terminate in a straight section 128 that is found at the bottom of the sipe. The half pitch HP_{R} of the second set of undulations typically ranges from 0.7 to 1.25 mm (approximately 0.028 to 0.049 of an inch) as measured from a peak 132 to an adjacent valley 134 in the radial direction R of the tire. At the same time, the amplitude A_{R} typically ranges 0.4 to 0.625 mm (approximately 0.016 to 0.025 of an inch) as measured from a peak 132 or valley 134 (surface of the sidewall 114, 116) to the midplane M_{R} of these undulations in a direction that is perpendicular to the midplane M_{R}. It should be noted that any range of values for the half pitch or amplitude could be used as long as twice the value of the amplitude is greater than 95% of the value of the half pitch which helps to increase the interlocking of the sipe and the rigidity of the block, which in conjunction with the thinned out regions of the sipe, provide a sipe with a significantly better performance than previous sipes as demonstrated by experimental results which are discussed later.

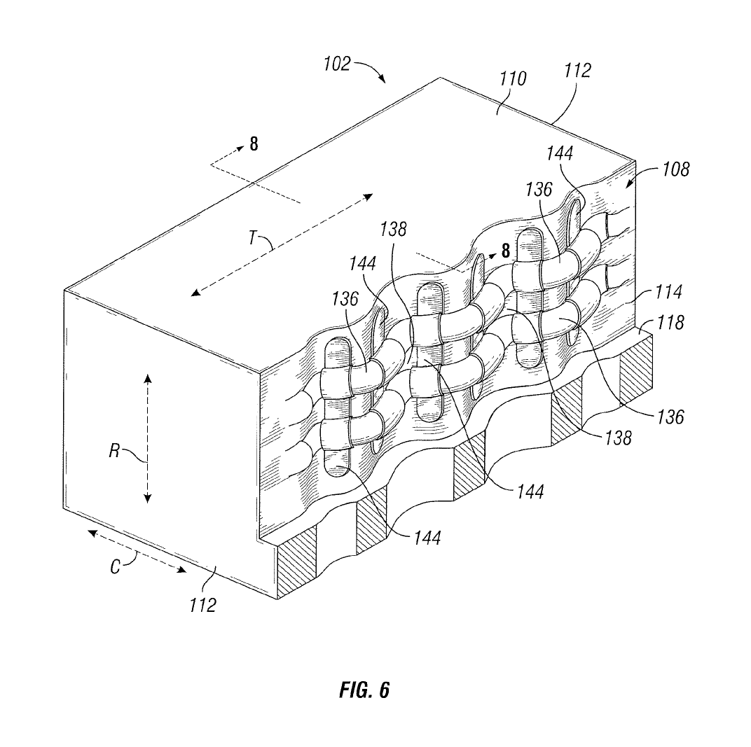

It is also contemplated that the half pitches and amplitudes of this set of undulations can be varied, and that the straight sections at the top and bottom of the sipe can be adjusted in length or eliminated altogether. Alternatively, an angled section near the top surface of the tread block could be provided to form a chamfer therewith. For this embodiment, the midplanes M_{T}, M_{R} of both set of undulations are coplanar, but it is contemplated that they do not necessarily need to be coplanar. Also, the starting points of each set of undulations are in alignment in the transverse direction T of the tire so that both sets of undulations are in phase with each other. Thus as shown in FIG. 6, the superposition of one set of undulations on the other set of undulations creates an egg crate looking pattern on the sipe with areas where peaks and valleys of each set of undulations periodically coincide with each other and where there is occasionally a peak to peak coincidence 136 or valley to valley coincidence 138. This does not necessarily need to be the case for all embodiments of the present invention.

Turning to FIGS. 2-6, another feature of the sipe that is shown is the existence of thicker and thinner regions, labeled as 140, 142 respectively, within the sipe 108 due to projections 144 found on one sidewall 114. The thin regions 142 are formed by long vertically oriented projections 144 that cover the majority of the surface area of the sipe found between the peak to peak or valley to valley coincidences 136, 138 of the undulations on the sidewall 114 and extend to within predetermined distances from the top surface 110 of the tread block and the bottom 118 of the sipe 108. The thickness T_{THICK} of the thick region of the sipe, as defined by the distance between the opposing sidewalls in a direction normal to the surfaces thereof, is four tenths of a millimeter (approximately 0.157 of an inch) while the thickness T_{THIN} of the thin regions, as defined by the distance between the projections 144 of one sidewall 114 to the other sidewall 116 in a normal direction is two tenths of a millimeter (approximately 0.079 of an inch), but these values could be varied. It is preferable to have a ratio of the surface area of the projections 144 on the sidewall 114 to the surface area of the portion of the sidewall 114 forming the thicker region 140 of the sipe 108 to be at least 25% so that the sipe will effectively close as quickly as possible when the tread block 102 enters the contact patch with enough contact area between the opposing sidewalls 114, 116 so as to create as stiff a tread block 102 as possible. It is also preferable that the areas having reduced thickness extend to 70% of the height of the sipe 108 to help ensure that the tread block 102 is stiff when it is in the contact patch.

Consequently, the projections 144 include peaks 126, 132 and valleys 124, 134 of the undulations to maximize the surface area of the regions 142 of the sipe 108 having reduced thickness without including any peak to peak or valley to valley coincidences 136, 138, which aids in the manufacture of a sipe blade as will be discussed later. As shown in this particular embodiment, the surface area of the projections 144 is at least 25% the surface area of the sidewall 114 that forms the thicker regions 140 of the sipe 108 but could be more. Also, the second sidewall 116 is complimentary shaped to the first sidewall 114 but does not have any projections 144 on it for forming the thinner regions 142 of the sipe 108. It is contemplated that the entire second sidewall 116 does not need to be complimentary shaped to the first sidewall 114.

Of course, the sipe 108 of the present invention could be altered. For example, the undulations are shown to alternate about a midplane but could have configurations that do not have this characteristic. So the undulations could include any geometry that varies causing an undercut in the radial or a non-radial direction of the tire. Also, the undulations do not need to have transitions with radii but could have abrupt changes in direction. Also, the thin regions shown by the figures is formed by projections found on only one sidewall but it could be formed by projections found on both sidewalls. Also, the sipe shown has undulations in both the radial and transverse R, T directions of the tire but it is possible that a sipe with undulations only extending in the radial direction (similar to what is shown in FIG. 7 except no projections are shown in that Figure for thinning out the sipe) with thinner and thicker regions having the desired surface area ratio of thin to thick areas of at least 25% could be used. Also, the sipe could extend in a direction that is not transverse but that is still substantially perpendicular to the radial direction of the tire. Also, the overall path of the sipes in both the radial and transverse R, T directions as shown is substantially linear along midplanes, M_{R} and M_{T}, but is contemplated that these paths could be something else such as curved. For example, see FIG. 5 of US Patent Application Publication No. 2008/0029193. The entire content of this publication is hereby incorporated by reference in its entirety. In addition, the thickness of the thick and thin regions of the sipe could be altered in any suitable manner including a varying manner or in a manner where the thickness could smoothly transition from a thick region to a thin region.

Looking now at Table 1, there is shown a comparison between the handling characteristics of a tire with sipes with undulations in both the transverse and radial directions having areas of reduced thickness and of a tire with similarly configured sipes lacking areas of reduced thickness, both of which follow the design rule discussed earlier concerning the ratio of the values of the half pitch and amplitude. First, there is a significant 3% improvement in the rolling resistance when the areas of reduced thickness are added. This can be attributed to the added stiffness created by the sipes since they close and interlock more quickly, reducing compressive losses that occur during rolling. Second, there is a 7% increase in the wear life performance which is a direct result of increased tread block stiffness. Third, there is a 2% improvement in dry braking. All three of these improved ratings are statistically significant. Fourth, there is no observed degradation in wet braking performance. As can be seen, the proper ratio of the amplitude and half pitch of the radial undulations in conjunction with the areas of reduced thickness provide the necessary means to break the traditional compromises between rolling resistance, wear life, dry braking and wet braking which is a desirable and unexpected result.

TABLE 1

| PERFORMANCE | | |
|---|---|---|
| CHARACTERISTIC | OLD SIPES | NEW SIPES |
| Rolling Resistance Index | 100 | 103 |
| Wear Life Index | 100 | 107 |
| Dry Braking Index | 100 | 102 |
| Wet Braking Index | 100 | 100 |

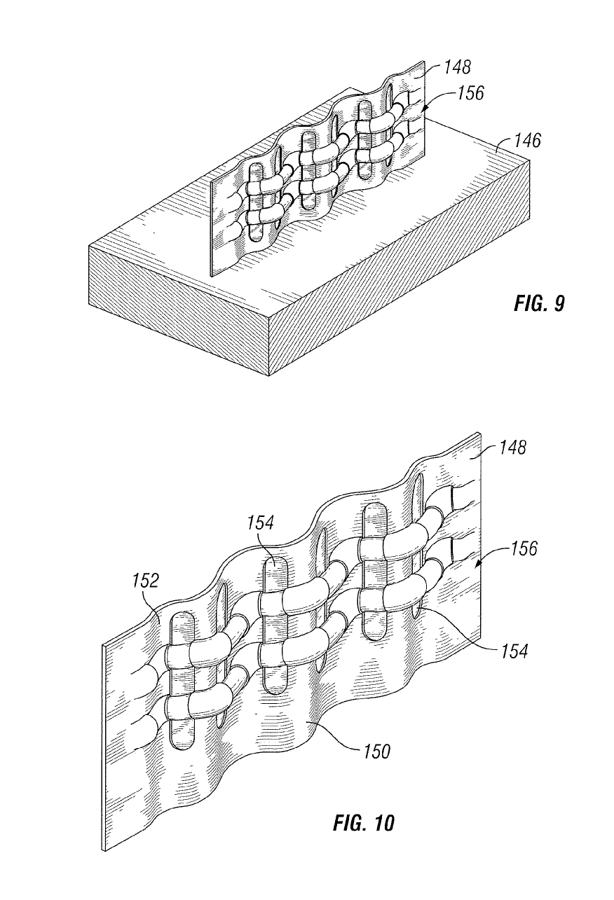

Turning to FIGS. 9 and 10, an apparatus that is capable of making a tire with such a sipe is shown. It comprises an apparatus for molding or retreading a tire that includes, in part, a curing member 146 from which a sipe blade 148 extends. While the curing member is shown to be flat, as would be the case in a retreading application, it could be a curved shaped mold sector that is used in a molding application. (Also, note that the projections of the curing member 146 for forming the grooves that define the tread block 102 into which the sipe blade 148 would normally extend have been omitted for clarity and that the apparatus would be inverted to form sipe 108.)

The sipe blade 148 is attached to the curing member 146 by any means commonly known in the art such as using lock pins or by casting. The sipe blade 148 has a first portion 150, with holes or undercuts (not shown) for retaining the blade 148 to the curing member 146 when it is attached thereto by casting and a second portion 152 that forms the sipe 108 of the tire. For this application, the first portion 150 of the sipe blade 148 extends 8 mm into the curing member 156 in order to provide sufficient holding strength when molding the sipe. The shape of the second portion 152 of the sipe blade 148 is the negative image of the sipe 108 with its sidewalls 156 forming the sidewalls 114, 116 of the sipe 108 with all of their undulations and projections. As a result, the blade 148 has a plurality of recesses 154 on one of its sidewalls that form the associated projections 144 found on one sidewall 114 of the sipe 108, creating the thin regions 142 or areas of reduced thickness of the sipe 108. The thickness of both the first portion 150 of the sipe blade 148 as well as the thick regions 140 of the second portion 152 of the sipe blade 148 are four tenths of a millimeter while the thickness of the recessed areas 154 of the blade are two tenths of a millimeter, but these thicknesses could be changed to create a sipe with any desired geometry. It is useful to have the first portion 150 of the blade 148 and the part of the second portion 152 of the blade 148 that is immediately next to the first portion 150 of the blade 148 be thicker as this provides the blade 148 with enough strength and durability where it extends from the curing member 146 so it can withstand stresses and cyclic fatigue as it makes sipes, allowing it to last longer.

Sipe blades are typically made from stainless steel but may be made from other materials having the desired properties. Furthermore, the shape and configuration of the sipe blade 148 may be altered and still fall within the scope of the present invention as long as it is the negative image of the sipes 108 discussed above. The sipe blade 148 may be made by any means known in the art such as the following. First, a plate of sheet stock having a thickness of four tenths of a millimeter is milled so that areas of reduced thickness are created in desired locations. Finally, a blank including the areas of reduced thickness is stamped out of the sheet stock and then folded into shape using a progressive die process. As can be seen, having a sipe 108 with projections 144 on only one sidewall is advantageous because it allows the recesses to be milled on only one side of sheet stock reducing the amount of time needed to manufacture the sipe blade 148. Also, during forming the bending stresses and deformation are greatest where there is a peak to peak or valley to valley coincidence 136, 138 so the recesses of the sipe blade 148 are strategically located in places where there is no such coincidence so that any failure of the blade 148 in thinned out areas is avoided. Alternatively, the sipe blade 148 may be made using a laser sintering (selective laser melting process) or other rapid prototyping technology (such as micro-casting) that allows the recesses to be formed on both sides of the sipe blade 148 for forming the thin region 142 of the sipe 108 without increasing the time to manufacture such a blade 148. When using such a technology, it is possible that the recesses of the blade and associated thinned out areas of the sipe could be found on a peak to peak or valley to valley coincidence since failure due to bending in these areas is not an issue since there is no bending. In particular, the technology disclosed in U.S. Pat. No. 5,252,264 can be used to make this embodiment of the blade. The content of this patent is incorporated herein by reference in its entirety.

While the embodiments of the sipe 108 and sipe blade 148 discussed herein have only undulations, other features could be added and still fall within the scope of the present invention. For example, the sipe 108 or sipe blade 148 could have a Y branch or tear drop feature found at its bottom portion. Similarly, other features could be found on the side or top portions of the sipe 108 or sipe blade 148 including chamfers. In similar fashion, the embodiments described above are specifically used in conjunction with a tread block 102, but it is possible that they could be used in conjunction with other tread elements such as a rib. Likewise, the present invention can be used on both pneumatic and non-pneumatic tires alike. Accordingly, these variations are also within the scope of the present invention.

As can be seen, the sipe and the apparatus for forming the sipe including a sipe blade and curing member, provide a way to make a tread block with sipes that is as flexible as possible when the tread block first enters or exits contact with the road, but that is as stiff as possible when the tread block is in contact with the road. This is accomplished primarily by providing the sipe with tight pitched undulations in the radial direction that have areas of reduced thickness, allowing the sipe to close up as quickly as possible when the tread block is in the contact patch. Hence, this sipe and sipe blade satisfy the aforementioned needs of providing a tread block that is flexible as possible when entering or exiting the contact patch and is as stiff as possible when in the contact patch. Also, this sipe configuration breaks the compromise that is typically found between different tire performances, providing a beneficial and unexpected result.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tire with a tread stock and a radial direction comprising:
a tread element; and
a sipe located within the tread element having first and second opposing sidewalls, said first sidewall having a first set of undulations in a radial direction of the tire with a half pitch and an amplitude wherein twice the value of the amplitude is greater than 95% of the value of the half pitch, said sipe having a thicker region with said opposing sidewalls being spaced apart a first predetermined distance, said sipe further comprising a region having a reduced thickness with the opposing sidewalls being spaced apart a second predetermined distance, said second predetermined distance being less than the first predetermined distance and the first sidewall of the region with a reduced thickness having a surface area that is at least 25% and less than 85% of the surface area of the sidewall of the thicker region of the sipe.

2. The tire of claim 1 wherein said sidewalls have complimentary shapes to each other.

3. The tire of claim 1 wherein said region having a reduced thickness is formed by first and second protrusions found on the first sidewall.

4. The tire of claim 1 wherein the sipe further comprises a second set of undulations in a direction that is substantially perpendicular to the radial direction of the tire and the half pitch of the first set of undulations ranges from approximately 0.7 millimeters to 1.25 millimeters and the amplitude ranges from 0.4 millimeters to 0.625 millimeters with twice the value of the amplitude always being greater than 95% of the value of the half pitch.

5. The tire of claim 4 wherein the undulations of the first sidewall in the radial direction of the tire has a midplane and the undulations of the first sidewall in a direction that is substantially perpendicular to the radial direction of the tire also has a midplane and wherein said midplanes are coplanar.

6. The tire of claim 5 wherein the first set of undulations of the first sidewall in the radial direction of the tire varies in a manner that is similar to a periodic wave with a starting point of zero amplitude and the second set of undulations of the first sidewall in a direction that is substantially perpendicular to the radial direction of the tire also varies in a manner that is similar to a periodic wave with a half pitch and an amplitude and also has a starting point of zero amplitude, wherein both starting points are aligned in the direction of the tire that is substantially perpendicular to the radial direction.

7. The tire of claim 6 wherein said undulations in both the radial direction of the tire and a direction that is substantially perpendicular to the radial direction of the tire have peaks and valleys that periodically coincide with each other and wherein peaks of one set of undulations periodically coincides with the peaks of the other set of undulations and wherein the valleys of one set of undulations periodically coincides with the valleys of the other set of undulations.

8. The tire of claim 7 wherein the region having reduced thickness of the sipe includes at least one peak or valley.

9. The tire of claim 7 wherein the region having reduced thickness of the sipe does not include a peak to peak or valley to valley coincidence.

10. The tire of claim 9 wherein the half pitch and amplitude of the undulations in the radial direction of the tire are not the same as the half pitch and amplitude of the undulations in the direction that is substantially perpendicular to the radial direction of the tire.

11. The tire of claim 10 wherein the half pitch is approximately 3.7 millimeters and the amplitude is approximately 0.75 millimeters for the undulations in the direction of the tire that is substantially perpendicular to the radial direction.

12. An apparatus for molding or retreading a tire having a tread and a radial direction comprising:
a curing member that has a curing surface that contacts the tread of the tire; and
a sipe blade that has a first set of undulations in a radial direction with a half pitch and an amplitude wherein twice the value of the amplitude is greater than 95% of the value of the half pitch and a second set of undulations in a direction that is substantially perpendicular to the radial direction of a tire, said first or second set of undulations forming at least one peak or valley and at least one peak to peak or valley to valley coincidence, said sipe blade having a thicker portion that extends from the curing member and a portion having reduced thickness that includes at least one peak or valley.

13. The apparatus of claim 12 wherein both sets of undulations of the sipe blade in both the radial direction and in a direction that is substantially perpendicular to the radial direction vary in a periodic manner and which have peaks and valleys that periodically coincide with each other with at least one peak to peak or valley to valley coincidence and wherein said portion of the sipe blade having a reduced thickness does not include any peak to peak or valley to valley coincidence.

14. The apparatus of claim 13 wherein the sipe blade comprises a series of portions having reduced thickness that are found between each of the peak to peak or valley to valley coincidences of the blade.

15. The apparatus of claim 14 wherein one set of undulations has a different half pitch and amplitude compared to the other set of undulations.

16. The apparatus of claim 15 wherein said amplitude for the undulations in the radial direction is approximately 0.5 millimeters and the half pitch is 0.9 millimeters and the amplitude for the undulations in the direction of the tire that is substantially perpendicular to the radial direction is approximately 0.75 millimeters and the half pitch is approximately 3.7 millimeters.

17. The tire of claim 1 or claim 4 wherein the amplitude or half pitch of the undulations varies.

18. The tire of claim 1 wherein the tread element has a top surface and the sipe has a chamfer where the sipe meets the top surface of the tread element.
